(19) United States
(12) Patent Application Publication
(10) Pub. No.: US 2014/0102951 A1
(43) Pub. Date: Apr. 17, 2014

(54) Sifter Apparatus

(71) Applicants: Vincent John Riha, Cleveland, OH (US); Christian Stewart Dixon, Cleveland, OH (US)

(72) Inventors: Vincent John Riha, Cleveland, OH (US); Christian Stewart Dixon, Cleveland, OH (US)

(21) Appl. No.: 13/653,287

(22) Filed: Oct. 16, 2012

(51) Int. Cl. B07B 1/00

(52) U.S. Cl. CPC B07B 1/00
USPC 209/233

(57) ABSTRACT

A sifter attachment for a stand mixer that sifts directly into the bowl; sifting can be done simultaneously while mixing wet mix

The present invention relates generally to mixing appliances, more particularly, to a stand mixer/sifter Combination.

### BACKGROUND

Stand Mixers are well known and widely used. Sifting material into these style mixers, while in operation or at rest, has proven to be difficult. Sifted materials create a larger volume, resulting in the use of less material. This can attribute to a cost saving feature. The less use of certain materials also produces healthier products. The use of sifted material produces a more favorable consistency in the final product. The design of the attachment supports cleaner work areas. The integration of this attachment simplifies the process of incorporating sifted materials into the mixing product.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

This apparatus is a sifting unit (Unit) to be used on stand-mixers (Mixer) with an accessory or auxiliary hub (Hub). This unit will attach to the mixer using the hub and will be driven by joining the unit's hub drive shaft with the mixer's hub drive connector. The unit's body wraps around the mixer's body and narrows to keep the lower opening of the unit's body within the confines or close proximity of the mixer's bowl.

In aspects, the Unit will include several components -there will be body and cover components, drive and transmission components, action components and hardware components. The body will be a multi chamber form, which will hold the ingredients to be sifted as well as the components that make up the functioning unit. The Covers will be used to close off access to the drive system as well as a cover to hold ingredients to be sifted in the sifting chamber for when the mixer head is tilted as well as for storage. A sifting mesh will attach to the body at the bottom of the body where ingredients being sifted will exit. The drive system may be comprised of an input shaft, translation gearing, clutch device, transmission or drive engagement device, output gearing, motion cam, motion arm, sifting arm, lever actuator, vibratory mechanism, dispensing system, pulsing routine and on/off device. The hardware components will be machine screws, set screws, pins, bearings, washers and seals where needed.

The innovation disclosed and claimed herein, in one aspect thereof, comprises a sifting device, which in combination with a stand mixer performs sifting simultaneously and single in a convenient and easy manner.

As an aspect of the invention, the sifter attachment may include a model ring and an input/connecting shaft that can mechanically be connected to said stand mixer.

As an aspect of the invention, the sifter attachment the model ring is interchangeable to allow the invention to be used on several models of stand mixers.

As an aspect of the invention, the sifter attachment reservoir may have a snap tight lid to allow the reservoir to be filled and allow the stand mixer top to be raised and lowered.

As an aspect of the invention, the sifter attachment has momentary engagement arm to allow the ingredients to be sifted at will. An alternate aspect of the invention allows a continuous drive engagement lever.

As a feature of the invention the input/connecting shaft is connected to a drive system that allows congruent speeds between mixing and sifting.

As a feature of the invention, the sifter attachment gear drive system includes a clutch or slip mechanism to prevent wear and/or damage to stand mixer.

As a feature of the invention, the sifter attachment the sifting screen and beater or action arm are replaceable to account for wear and improper use.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1: is an example schematic illustration of a front view of the sifter attachment of the present invention.

FIG. 2: is an example schematic illustration of a top view of the sifter attachment of the present invention.

FIG. 3: is an example schematic illustration of a rear view of the sifter attachment of the present invention.

FIG. 4: is another example perspective illustration of the sifter attachment of the present invention.

FIG. 5: is another example schematic illustration of the sifter attachment of the present invention. Showing a typical mechanical arrangement of the internal components

FIG. 5A: is a schematic illustration of the sifter attachment of the present invention. Showing a detailed section of FIG. 5 with the locking ring not shown.

FIG. 6: is an example rendering showing the manual operator attachment.

FIG. 7: is an example rendering showing the manual operator attachment from the opposite side.

FIG. 8: is an example perspective view of the sifter attachment them the manual operator of the present invention.

FIG. 9: is an example perspective view of the sifter attachment them the manual operator of the present invention.

FIG. 10: is an example perspective view of a stand mixer and the sifter attachment of the present invention.

FIG. 11 shows some of the alternate movement mechanisms available to the invention.

FIG. 11 A-A shows a section of the alternate movement mechanisms in FIG. 11.

### DETAILED DESCRIPTION

The Concept:

A sifter attachment for a stand mixer that sifts directly into the bowl; sifting can be done simultaneously while mixing wet mix.

The Design:

A form fitting contoured hopper with an internal sifting mechanism that is attaches to the stand mixer and is driven off the front or auxiliary attachment port of the stand mixer. The unit can be produced to fit on the right or the left side of the mixing head. The unit can be made from several different materials. The unit is scalable and produced in several sizes to accommodate stand mixers for residential, commercial, and industrial use. The hopper may include lids for product containment feature applied to the top and bottom openings.

The Operation:

The end user will attach the Unit to the Mixer; the mixer head will still be able to tilt to allow user to access the bowl to add ingredients. The user can add ingredients not requiring sifting directly in to the mixer's bowl from the opposite side of the head or by tilting the heads on models that tilt. The user will add the ingredient to be sifted to the Unit's hopper. The user will then engages the mixer's drive and begin combining ingredients at such point it is needed. The user will engage the unit's drive and begin sifting ingredients into the mixture within in the bowl currently being mixed.

The Purpose:

To allow users of stand mixers to sift directly in to the bowl while mixing their recipes. The design prevents loss of product that would otherwise miss the bowl of the mixer due to design of conventional sifters. The unit also prevents sifted ingredients from settling after sifting at a different location. One lid or containment feature would allow the user to tilt the top portion of the mixer while product is present in the hopper. The other lid will allow the outlet to be covered to allow the unit to be used as a storage container. Directions and guidelines for using mixer and sifted product versus un-sifted products will be provided.

The Mixer attachment of the present invention is a self-contained assembly that attaches to an existing stand mixer.

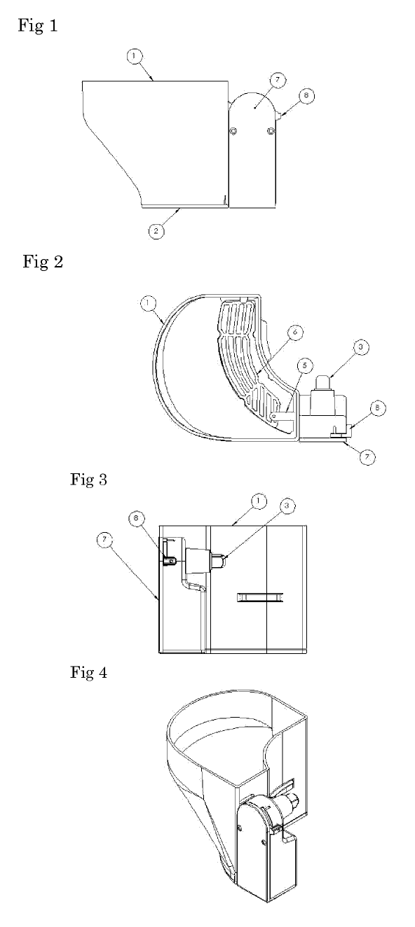

FIG. 1 shows the invention (B) front view. It shows the main hopper (1), the mechanism cover (7), the drive stop(8), & the sifter screen(2).

FIG. 2 shows the invention (B) top view. This view shows the arrangement of the main components. The main hopper (1), The sifter arm (6), the push arm (5), The input shaft (3), the from cover (7), & the drive stop (8).

FIG. 3 shows the invention (B) rear view. This view shows the arrangement of the main components. The main hopper (1), the input shaft (3), the front cover (7), & the drive stop (8).

FIG. 4 shows the invention (B) perspective view.

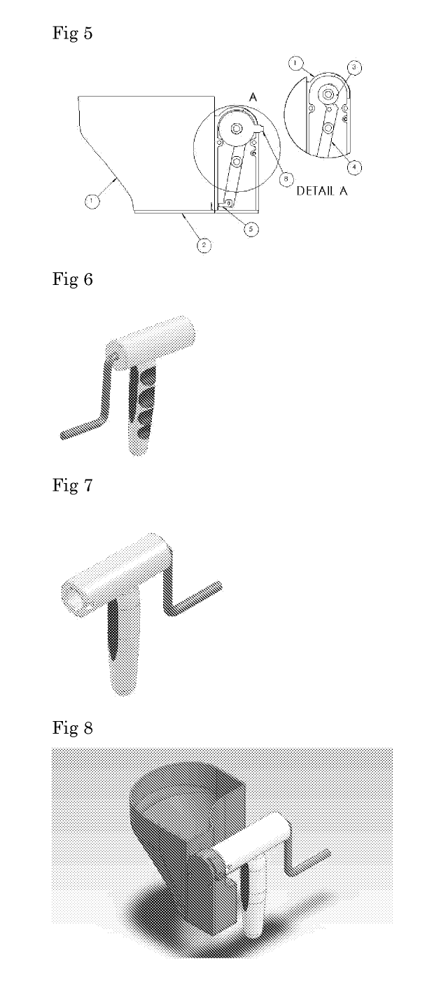

FIG. 5 illustrates the internal mechanism. This view shows the arrangement of the main components. The main hopper (1), The sifter screen (2), the input shaft (3), the movement arm (4), the push arm (5), & the drive stop (8). The movement is started when the stand mixer applies movement to the input shaft (3) which engages the movement arm, that in turns moves the pusher arm (5) and the sifter arm (6). When rotated to engage the drive stop arm (8) will prevent the input shaft (3) from engaging the movement arm (4) which then stops the pusher arm (5) and the sifter arm (6).

FIGS. 6 & 7: show the manual operator attachment.

FIGS. 8 & 9: shows the invention (B) with the manual attachment connected.

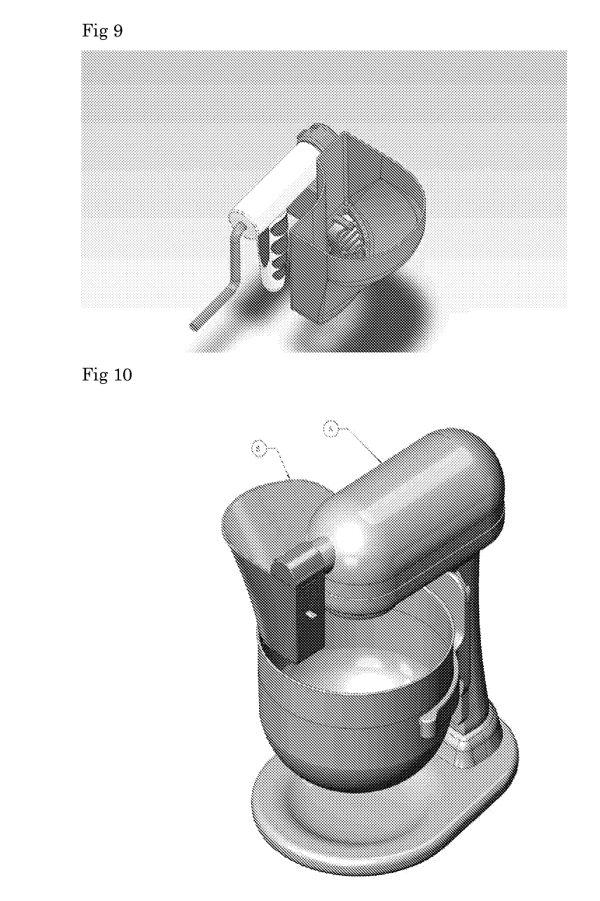

FIG. 10 shows the invention (B) attached to an existing stand mixer (A).

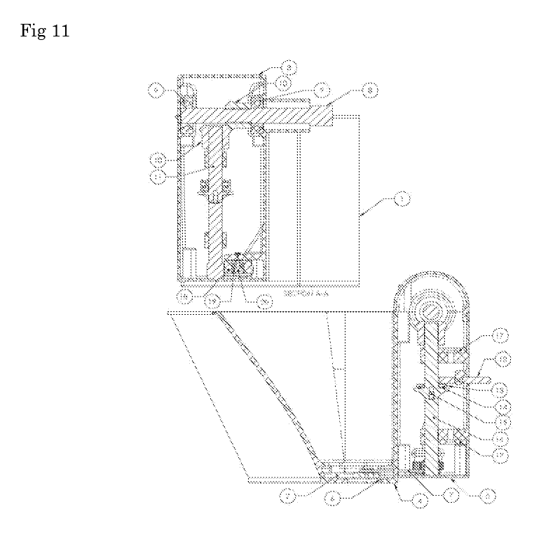

FIG. 11 shows some of the alternate movement mechanisms available to the invention. The input/connecting shaft (8) rides on two bearings (9) and receives power from the stand mixer (A) using bevel gears (10) the input shaft directs power to the Upper Drive shaft (11) the upper drive shaft is held in place using a yoke (17) attached to a boss within the gear housing. The Upper shaft is held off from the lower shaft (16) using a rotating pin (15) before the lower shaft (16) is engaged by the upper shaft (11). Engagement of the lower shaft is achieved when the engagement arm (12) is activated by the user. The engagement arm (12) applies force/pressure to clutching mechanisms (13 & 14). When the lower shaft (16) rotates it rotates cam gear (18), which revolves around pin (20) on bearings (19). Attached to the cam gear is the drive link (7) the opposing end of the drive link (7) is attached to the sifting arm (2). The drive link (7) rotates on the cam gear (18) in an eccentric pattern which effects the sifting arm (2) in a back and forth motion. This motion manipulates the ingredients through the sifter screen (6) creating uniform sized particles and passes them through the output chute in to the stand mixer bowl (A1). As the stand mixer mixes base ingredients the user decides when to activate the sifter (B) using the engagement arm (12) which will engage the gear drive mechanism to activate the sifting arm (2) causing the ingredient to be sifted from the reservoir in to the mixture.

The Sifter attachment will be available with some options, these options are described as such; a hand crank mechanism can be supplied for manual and auxiliary use of the attachment. A variable speed transmission is also available. There are a number of vibratory system options available such as an eccentric counter-spinning shaft, or electric add on vibrator. Some of the internal options include a pulsing drive mechanism to intermittently dispense product, a dispensing system to perform timed or sequenced dispensing of product, and variable speed drive to adjust for product density. Optional accessories to allow the attachment wider range of operation include various wiper and motion arms for sifting, chopping, powdering, and such. Also available are different size screens or sieve plates.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. In a stand-mixer having a mixing bowl, a mixer drive motor, an accessory or auxiliary hub in communication with said mixer drive motor, and a first drive shaft in mechanical communication with said drive motor and terminating at a drive shaft connector, wherein the improvement comprises:
a sifting apparatus attachable to the mixer using the hub; and
a second input drive shaft for operatively actuating the sifting apparatus;
wherein said sifting apparatus is driven by joining the second input drive shaft with the drive shaft connector.

2. (canceled)

3. (canceled)

4. The improvement of claim 1, wherein said sifting apparatus further comprises:
a hopper body forming a sidewall circumscribing a holding volume adapted for the containment of sifted ingredients;
an upper opening formed at a top of said sidewall for accessing said holding volume;
a lower opening forming a discharge at a bottom of said sidewall, said lower opening adapted for and positionable such as to allow for discharged contents to directly access said mixing bowl; and
a sifting mesh spanning and cover said lower opening.

5. The improvement of claim 4, wherein said sifting apparatus further comprises said hopper body being contoured about said mixer drive motor such as to maintain close proximity with said mixing bowl.

6. The improvement of claim 4, wherein said sifting apparatus further comprises:
a motion cam affixed to and rotatably urged by said second input drive shaft;
a moment arm pivotally connected between said motion cam at an upper end and a push arm at a lower end;
said push arm in contact between said lower end and said sifting mesh and being laterally reciprocating;
wherein rotation of the motion cam rocks said moment arm to translate the push arm in a manner that causes said sifting mesh to move fore and back laterally and thereby causing a sifting discharge of contents from said holding volume.

7. The improvement of claim 6, wherein said sifting apparatus further comprises a translation between said second input drive shaft and said motion cam for varying the speed or torque between said second input drive shaft and said motion cam.

8. The improvement of claim 4, wherein said sifting apparatus further comprises a drive stop mechanism for ceasing motion between said motion cam and said moment arm.

9. The improvement of claim 4, further comprising an independent operator for imparting rotary motion to second input drive shaft independent of said stand mixer.

10. The improvement of claim 9, wherein said independent operator further comprises a hand crank adapted for manual rotary manipulation.

11. The improvement of claim 6, further comprising an adapter for allowing operative attachment of said sifting apparatus to a variant designed stand-mixer.

12. The improvement of claim 5, wherein said sifting apparatus is adapted such that said hopper body can be alternately affixed to a right side of said mixer drive motor or a left side of said mixer drive motor.

13. A sifter for a stand mixer that sifts directly into a mixing bowl, said sifter comprising:
a hopper body forming a sidewall circumscribing a holding volume adapted for the containment of sifted ingredients;
an upper opening formed at a top of said sidewall for accessing said holding volume;
a lower opening forming a discharge at a bottom of said sidewall, said lower opening adapted for and positionable such as to allow for discharged contents to directly access said mixing bowl;
a sifting mesh spanning and cover said lower opening;
a motion mechanism for moving said sifting mesh in a back and forth motion, thereby manipulating the ingredients through said sifter mesh to create a more uniform particle size distribution of solids passing said lower opening and directly into a stand mixer bowl;

14. The sifter for a stand mixer of claim 13, wherein said back and forth motion of said sifting mesh is further in an eccentric pattern.

15. The sifter for a stand mixer of claim 13, wherein said motion mechanism is attachable to an accessory or auxiliary hub of said stand mixer that is in communication with a mixer drive motor such that said motion mechanism it in mechanical communication with said mixer drive motor.

16. The sifter for a stand mixer of claim 15, wherein said hopper body is contoured about said mixer drive motor such as to maintain close proximity with said mixing bowl.

17. A method of sifting material into a mixing bowl of a stand mixer comprising:
a. obtaining a hopper body having a sidewall circumscribing a holding volume adapted for the containment of sifted ingredients, said hopper body further forming an upper opening at a to and a lower opening forming a discharge at a bottom;
b. positioning said hopper body such as to allow for contents passing through said discharge to directly access said mixing bowl;
c. imparting a back and forth motion to a sifting mesh spanning and cover said lower opening, thereby manipulating the ingredients through said sifter mesh to create a more uniform particle size distribution of solids passing said lower opening and directly into a stand mixer bowl;
wherein said back and forth motion is imparted by a linkage in mechanical communication with an accessory or auxiliary hub of said stand mixer that driven by a mixer drive motor.

18. The method of sifting material into a mixing bowl of a stand mixer of claim 17, wherein said back and forth motion of said sifting mesh is further in an eccentric pattern.

19. The method of sifting material into a mixing bowl of a stand mixer of claim 17, wherein said hopper body is contoured about said mixer drive motor such as to maintain close proximity with said mixing bowl.
